(19) United States
(12) Patent Application Publication
(10) Pub. No.: US 2016/0343366 A1
(43) Pub. Date: Nov. 24, 2016

(54) SPEECH SYNTHESIS MODEL SELECTION

(71) Applicant: Google Inc., Mountain View, CA (US)

(72) Inventors: Javier Gonzalvo Fructuoso, London (GB); Byungha Chun, Epsom (GB)

(21) Appl. No.: 14/716,063

(22) Filed: May 19, 2015

(51) Int. Cl. G10L 13/027; G10L 13/08; G10L 13/047

(52) U.S. Cl. CPC G10L 13/027; G10L 13/047; G10L 13/086

(57) ABSTRACT

In some implementations, a text-to-speech system may perform a mapping of acoustic frames to linguistic model clusters in a pre-selection process for unit selection synthesis. An architecture may leverage data-driven models, such as neural networks that are trained using recorded speech samples, to effectively map acoustic frames to linguistic model clusters during synthesis. This architecture may allow for improved handling and synthesis of combinations of unseen linguistic features.

### TECHNICAL FIELD

This disclosure describes technologies related to speech synthesis.

### BACKGROUND

Text-to-speech systems can be used to artificially generate an audible representation of a text. Text-to speech systems typically attempt to approximate various characteristics of human speech, such as the sounds produced, rhythm of speech, and intonation.

### SUMMARY

In general, an aspect of the subject matter described in this specification may involve a text-to-speech system that performs a mapping of acoustic frames to linguistic model clusters in a pre-selection process for unit selection synthesis. An architecture may leverage data-driven models, such as neural networks that are trained using recorded speech samples, to effectively map acoustic frames to linguistic model clusters during synthesis. This architecture allows for improved handling and synthesis of combinations of unseen linguistic features.

For example, an architecture may perform this pre-selection process with textual input by performing an acoustic-linguistic regression and an acoustic-model mapping. The models identified through this mapping may indicate the candidate units available for unit selection. By taking acoustic information into account, this architecture may be able to classify unseen linguistic context according to what has been seen in the data utilized to train its neural networks.

For situations in which the systems discussed here collect personal information about users, or may make use of personal information, the users may be provided with an opportunity to control whether programs or features collect personal information, e.g., information about a user's social network, social actions or activities, profession, a user's preferences, or a user's current location, or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, such as to a city, zip code, or state level, so that a particular location of a user cannot be determined. Thus, the user may have control over how information is collected about him or her and used by a content server.

In some aspects, the subject matter described in this specification may be embodied in methods that may include the actions of receiving textual input to a text-to-speech system, identifying a particular set of linguistic features that correspond to the textual input, providing the particular set of linguistic features as input to a first neural network that has been trained to identify a set of acoustic features given a set of linguistic features, receiving, as output from the first neural network, a particular set of acoustic features identified for the particular set of linguistic features, providing a representation of the particular set of acoustic features as input to a second neural network that has been trained to identify a text-to-speech model given a set of acoustic features, receiving, as output from the second neural network, data that indicates a particular text-to-speech model for the representation of the particular set of acoustic features, and generating, based at least on the particular text-to-speech model, audio data that represents the textual input.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. For instance, providing the representation of the particular set of acoustic features as input to the second neural network that has been trained to identify a text-to-speech model given a set of acoustic features, may include providing the representation of the particular set of acoustic features as input to a second neural network that has been trained, independently from the first neural network, to identify a text-to-speech model given a set of acoustic features.

In some implementations, receiving, as output from the first neural network, the particular set of acoustic features identified for the particular set of linguistic features may include receiving, as output from the first neural network, a particular set of acoustic features including one or more of spectrum parameters, fundamental frequency parameters, and mixed excitation parameters identified for the particular set of linguistic features.

In some examples, the methods may include providing, as input to the second neural network that has been trained to identify a text-to-speech model given a set of acoustic features, data that indicates a particular quantity of frames of audio data that are to be generated. For instance, receiving, as output from the second neural network, data that indicates the particular text-to-speech model for the representation of the particular set of acoustic features may include receiving, as output from the second neural network, data that indicates a particular text-to-speech model for (i) the representation of the particular set of acoustic features and (ii) the particular quantity of frames of audio data to be generated, and generating, based at least on the particular text-to-speech model, audio data that represents the textual input may include generating, based at least on the particular text-to-speech model, frames of audio data of at least the particular quantity that represent the textual input. In some implementations, the second neural network is a recurrent neural network.

In some aspects, identifying the particular set of linguistic features that correspond to the textual input may include identifying a sequence of linguistic features in a phonetic representation of the textual input. In some examples, generating, based at least on the particular text-to-speech model, audio data that represents the textual input may include selecting one or more recorded speech samples based on the particular text-to-speech model indicated by the output of the second neural network.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIGS. 1 and 2 are block diagrams of example systems for providing text-to-speech services.

FIG. 3 is a flowchart of an example process for providing text-to-speech services.

FIG. 4 is a diagram of exemplary computing devices.

Like reference symbols in the various drawings indicate like elements.

### DETAILED DESCRIPTION

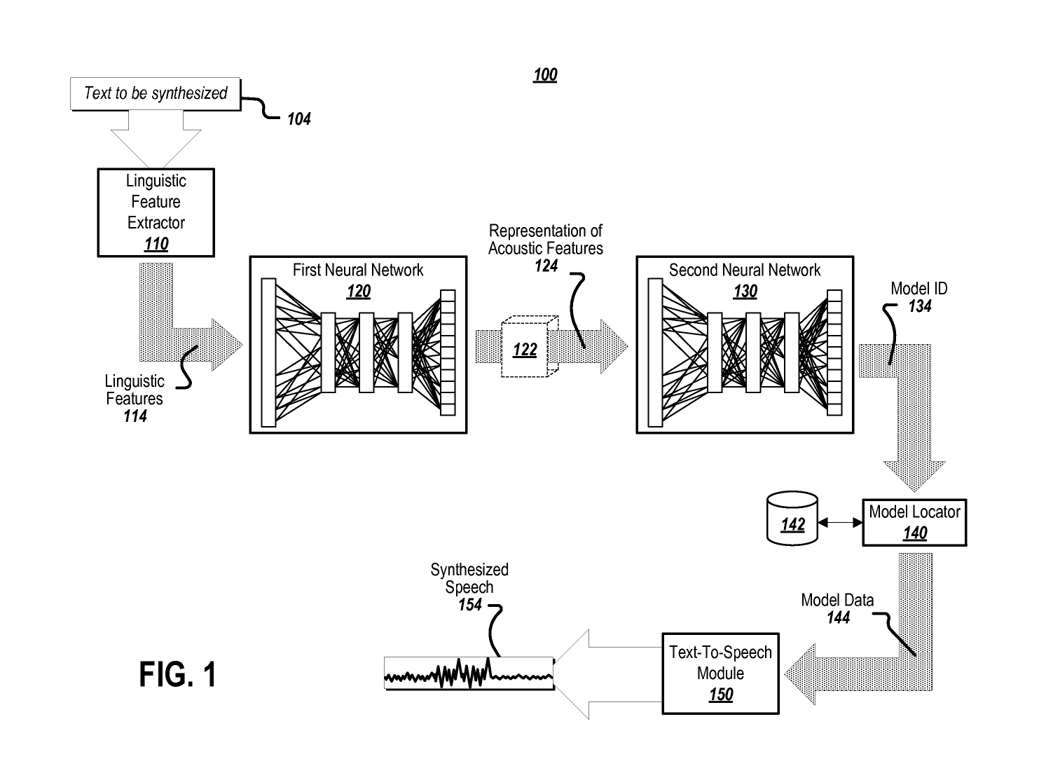

FIG. 1 is a block diagram that illustrates an example of a system 100 for providing text-to-speech services. The system 100, which may be implemented using one or more computing devices, may generate synthesized speech 154 from text 104. The one or more computing devices may, for example, provide the synthesized speech 154 to a client device over a network. The client device may play the received synthesized speech 154 aloud for a user.

The text 104 may be provided by any appropriate source. For example, a client device may provide the text 104 over a network and request an audio representation.

Alternatively, the text 104 may be generated by the one or more computing devices, accessed from storage, received from another computing system, or obtained from another source. Examples of texts for which synthesized speech may be desired include text of an answer to a voice query, text in web pages, short message service (SMS) text messages, e-mail messages, social media content, user notifications from an application or device, and media playlist information.

The system 100 may, for instance, use unit selection to generate synthesized speech 154 from text 104. That is, the system 100 may synthesize speech to represent text 104 by selecting recorded speech samples from among a database of recorded speech samples and concatenating the selected recorded samples together.

Ideally, this concatenation of select recorded samples, or synthesized speech 150, may adequately represent text 104 when produced. Each recorded speech sample may be stored in the database in association with a corresponding symbol, e.g., phone and context phone of the speech in the recorded sample. In this way, speech sample and symbol pairings may be treated as units.

The unit selection performed by system 100 may include a unit pre-selection process. As an example, a unit pre-selection process might include identifying a model which indicates a set of candidate units which may be utilized for synthesis. The candidate units included in each model may share a same linguistic context.

In some implementations, the system 100 may map linguistic features of a portion of textual input 104 to a particular model. Such a pre-selection process may be performed for each portion of textual input 104. In this way, speech samples may be selected for each portion of the textual input 104 from among the multiple speech samples associated with the model that was pre-selected for the respective portion of the textual input 104. In some examples, the system 100 may leverage one or more neural networks to map linguistic features to models.

During synthesis, the one or more computing devices may be tasked with generating synthesized speech to represent textual input that includes one or more combinations of linguistic features that the system 100 has not previously encountered. It can be seen that a one-to-one mapping of linguistic features to models may not be feasible in situations in which unseen linguistic features are considered.

In examples which leverage one or more neural networks to map linguistic features to models, the system 100 may introduce additional information into its mapping processes in order to handle such unseen contexts. Such additional information may include acoustic information. By taking acoustic information into account, a neural network configuration of system 100 may map unseen linguistic contexts to models according to what may have been seen by neural networks of system 100 in the data upon which they have been trained.

In some implementations, the neural network configuration of system 100 capable of handling unseen linguistic contexts may be one that effectively provides a mapping of acoustic frames to linguistic model clusters. Specifically, this configuration may include a linguistic feature extractor 110, a first neural network 120, a second neural network 130, a model locator 140, and a text-to-speech module 150.

The first neural network 120 and the second neural network 130 may be trained using recorded speech samples. In some examples, some or all of these recorded speech samples may be those which belong to the database from which recorded speech samples are selected and concatenated in speech synthesis processes.

The process of mapping acoustic frames to linguistic model clusters may be seen as having at least a first step and a second step that are performed by the first neural network 120 and the second neural network 130, respectively. In some implementations, the first neural network 120 may be trained to identify a set of acoustic features given a set of linguistic features. In these implementations, the second neural network 130 may be trained to identify a model given a set of acoustic features.

By utilizing the first neural network 120 and the second neural network 130 in a series arrangement, such as that depicted in FIG. 1, it can be understood that the first neural network 120 and the second neural network 130 may carry-out pre-selection processes, such as those described above, in performing a first step of mapping linguistic features to acoustic features and a second step of mapping acoustic features to models.

In some implementations, the first step of mapping linguistic features to acoustic features that is performed by the first neural network 120 may be an acoustic-regression. In operation, the linguistic feature extractor 110 may identify a set of linguistic features 114 that correspond to the textual input 104 and provide the set of linguistic features 114 to the first neural network 120.

The set of linguistic features 114 identified by the linguistic feature extractor 110 may include a sequence of phonetic units, such as phonemes, in a phonetic representation of the text 104. The linguistic features can be selected from a phonetic alphabet that includes all possible sounds with which the first neural network 120 is trained to be used. Given the linguistic features 114, in some implementations the first neural network 120 may output a representation of acoustic features 124.

The representation of acoustic features 124 may be real values which parameterize audio, such as spectrum, fundamental frequency, and excitation parameters. In some implementations, the representation of acoustic features 124 may be those which the first neural network 120 considers to be ideal for the given linguistic features 114.

In other implementations, the representation of acoustic features 124 may be those which correspond to one of the recorded speech samples from which the textual input 104 is to be synthesized. In these implementations, the first neural network 120 may provide ideal acoustic features as an output to a module 122 which identifies acoustic features that correspond to one of the recorded samples from which the textual input 104 is to be synthesized and most closely match the ideal acoustic features output by the first neural network 120.

In some implementations, the second step of mapping acoustic features to models that is performed by the second neural network 130 upon receiving the representation of acoustic features 124 output by the first neural network 120. In operation, the second neural network 130 may map the representation of acoustic features 124 to a particular model. The second neural network 130 may, for example, output a model identifier (“ID”) 134 which may indicate the particular model selected for the given acoustic features.

The model ID 134 may be provided to the model locator 140. For example, the model locator 140 may access a database of units 142 and identify the set of candidate units associated with a given model ID. Model data 144 that indicates one or more candidate units associated with the given model ID 134 may be provided the text-to-speech module 150 for generated synthesized speech 154.

Although the first neural network 120 and the second neural network 130 may be trained using the same data, such as that of a same database of units, they may also be trained independently. This may, for instance, allow the first neural network 120 and the second neural network 130 to generate their own acoustic subspace in their hidden layers.

The first neural network 120 may, for example, be implemented as a deep or recursive neural network. The second neural network 130 may be trained with acoustic features from the recorded speech samples, with model IDs being classified in the output with a relatively large softmax layer. Hidden layers in the second neural network 130 may create a subspace of the acoustics which are likely to be successful for acoustic features received during synthesis.

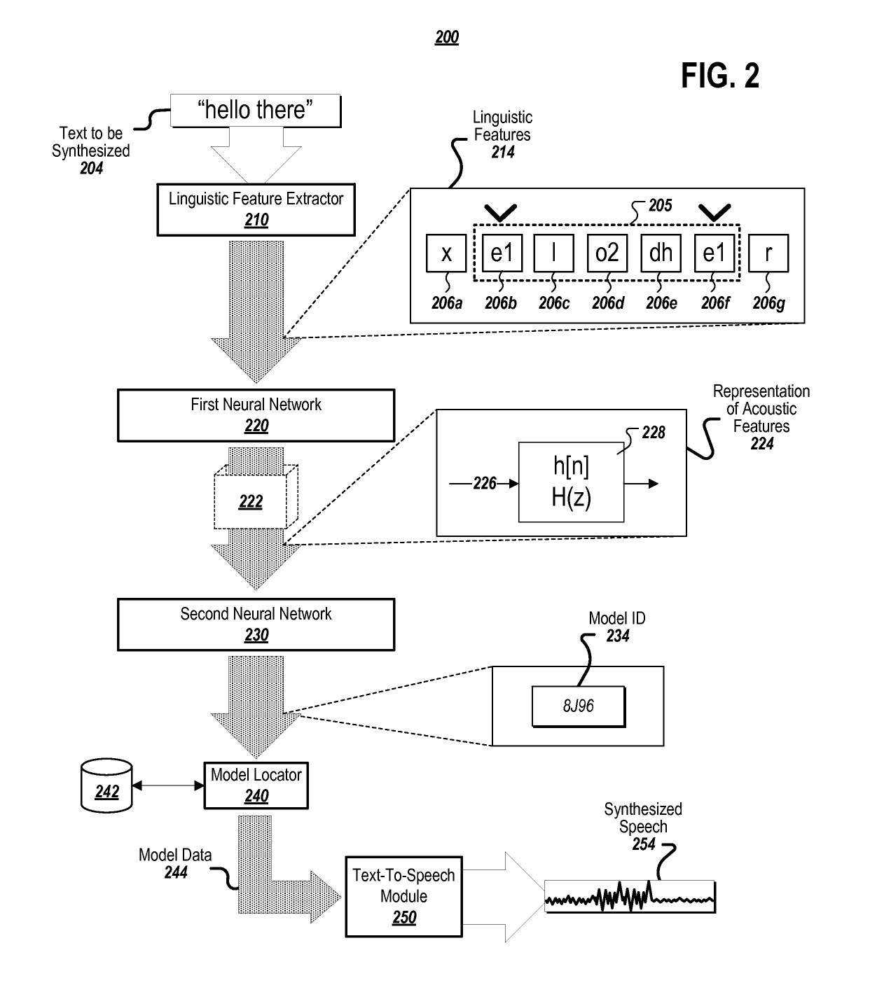

FIG. 2 is a diagram 200 that illustrates an example of providing text-to-speech services. The diagram 200 illustrates in greater detail processing that the one or more computing devices of the system 100 or another computing system may perform to synthesize speech from textual input.

In the example of FIG. 2, the one or more computing devices receive textual input 204, which includes the phrase “hello there.” The linguistic feature extractor 210 extracts linguistic features 214, e.g., phonemes, from the text 204. For example, the linguistic features extractor 210 determines a sequence 214 of phonetic units 206a-206g that form a phonetic representation of the text 204. The phonetic units 206a-206g shown for the text 204 are the phones “x e1 I o2 dh e1 r.”

The linguistic feature extractor 210 determines which phonetic units 206a-206g are stressed in pronunciation of the text 204. The one or more computing devices may obtain information indicating which phonetic units are stressed by looking up words in the textual input 204 in a lexicon or other source. A stressed sound may differ from unstressed sound, for example, in pitch (e.g., a pitch accent), loudness (e.g., a dynamic accent), manner of articulation (e.g., a qualitative accent), and/or length (e.g., a quantitative accent).

The type of stress determined can be lexical stress, or the stress of sounds within individual words. In the illustrated example, the phonetic unit 206b “e1” and the phonetic unit 206 “e1” are identified as being stressed. In some implementations, a different linguistic symbol may be used to represent a stressed phonetic unit. For example, the label “e1” may represent a stressed “e” sound and the label “e2” may represent an unstressed “e” sound.

The linguistic feature extractor 210 may determine groups of phonetic units 206a-206g that form linguistic groups. The linguistic feature extractor 210 may determine the linguistic groups based on the locations of stressed syllables in the sequence 214. For example, the stressed phonetic units 206b, 206f can serve as boundaries that divide the sequence 214 into linguistic groups that each include a different portion of the sequence 214.

A linguistic group can include multiple phonemes. The linguistic groups are defined so that every phonetic unit in the sequence 214 is part of at least one of the linguistic groups. In some implementations, the linguistic groups are overlapping subsequences of the sequence 214. In some implementations, the linguistic groups are non-overlapping sub-sequences of the sequence 214. A linguistic group may be defined to include two stressed phonetic units nearest each other and the unstressed phonetic units between the stressed phonetic units.

For example, the linguistic group 205 is defined to be the set of phonetic units from 204b to 204f, e.g., “e1 I o2 dh e1 .” Linguistic groups may also be defined from the beginning of an utterance to the first stressed phonetic unit and from the last stressed phonetic unit to the end of the utterance. For example, the sequence 214 may divided into three linguistic groups: a first group “x e1 ,” a second group “e1 I o2 dh e1,” and a third group “e1 r.” In this manner, the stressed phonetic units overlap between adjacent linguistic groups.

When linguistic groups overlap, if different acoustic features generated for the overlapping phonetic units, the different acoustic feature values may be combined, e.g., weighted, averaged, etc., or one set of acoustic features may be selected. In some implementations, phonetic units from the sequence of linguistic features 214 may divided into groups of two or more phonetic units. In such implementations, each linguistic group may correspond to a diphone representative of a different linguistic portion of textual input 204.

To obtain acoustic features, the one or more computing devices provide at least a portion of linguistic features 214 to the first trained neural network 220. In some implementations, the linguistic features 214 are provided to the first neural network 220, one at a time.

For instance, a set of linguistic features provided to the first neural network 220 may be those of a linguistic group. In this way, the first neural network 220 may be able to perform acoustic-regression for each individual portion of textual input 204. The phonetic units of the linguistic features 214 may be expressed in binary code so that the first neural network 220 can process them. For each set of linguistic features 214 provided, the first neural network 220 outputs a corresponding set of acoustic features 224. Thus, the first neural network 220 can map linguistic features to acoustic features.

The set of acoustic features 224 provided by the first neural network 220 may include acoustic features of an audio segment which corresponds to the input linguistic features. In some implementations, the acoustic features 224 may include one or more parameters of a source-filter model that is representative of the audio segment. Such acoustic features 224 may include any digital signal processing (“DSP”) parameters that indicate characteristics of one or more of a source 226 and a filter 228 of an exemplary source-filter model that is representative of the audio segment.

For example, one or more of spectrum parameters, fundamental frequency parameters, and mixed excitation parameters may be provided to describe one or more aspects of the source 226 and/or filter 228. Fundamental frequency parameters may, for example, include various fundamental frequency coefficients which may define fundamental frequency characteristics for the audio segment corresponding to the input linguistic features. The frequency coefficients for each of the linguistic features may be used to model a fundamental frequency curve using, for example, approximation polynomials, splines, or discrete cosine transforms.

It is understood that the output of the first neural network 220 may depend on the linguistic features 214 that are input. For instance, linguistic features such as voiced phones may be mapped by the first neural network 220 to acoustic features corresponding to parameters of a source-filter model with a source which may be modeled as a periodic impulse train. In another example, linguistic features such as unvoiced phones may be mapped by the first neural network 220 to acoustic features corresponding to parameters of a source-filter model with a source which may be modeled as white noise.

In some implementations, the representation of acoustic features 224 may be those which the first neural network 220 considers to be ideal for the given linguistic features 214. In other implementations, the representation of acoustic features 224 may be those which correspond to one of the recorded speech samples from which the textual input 204 is to be synthesized. In these implementations, the first neural network 220 may provide ideal acoustic features as an output to a module 222 which identifies acoustic features that correspond to one of the recorded samples from which the textual input 204 is to be synthesized and most closely match the ideal acoustic features output by the first neural network 220.

To obtain a model ID, the representation of acoustic features 224 may be provided to a second neural network 230. The features included in the representation of acoustic features 224 may be expressed in binary code so that the second neural network 230 can process them. For each set of acoustic features 224 provided, the second neural network 230 outputs a corresponding model ID 234. Thus, the second neural network 230 can map acoustic features to models.

In some implementations, the second neural network 230 may also receive data that indicates a particular quantity of frames of audio data that are to be generated. In other words, the duration of time in which samples from the model to which it maps the acoustic features 224 will occupy in the synthesized speech may be communicated to the second neural network 230. That is, the duration information may also be indicative of the number of acoustic features 224 which may be needed in order to generate each linguistic feature.

In some examples, the second neural network 230 may perform its acoustic-model mapping based at least on the representation of acoustic features 224 and the quantity of frames of audio data that are to be generated. Such duration information may be estimated by a module other than those depicted in FIG. 2.

For example, a third neural network positioned upstream from both the first neural network 220 and the second neural network 230, but downstream from the linguistic feature extractor 210 may be provided for estimating duration information, e.g., quantity of frames of audio data to be generated. The output of the third neural network that maps linguistic features 214 to duration information may be provided directly to the second neural network 230. In this way, the output of the third neural network may bypass the first neural network 220. In these examples, the third neural network may simply provide the first neural network 220 with the linguistic features 214 that it has received from the linguistic feature extractor 210 so that the first neural network 220 may function as described above.

The model ID 234 output from the second neural network 230 may be provided to model locator 240. In some implementations, the model ID 234 is a simple identifier which indicates a set of candidate units. For example, the model ID 234 may be a pointer to the set of candidate units or a code which may be used to locate the set of candidate units of the model.

The model locator 240 may have access to a database 242, which may store information for all units which may be utilized in synthesis. In some examples, the model locator 240 may query the database 242 with the model ID 234 to retrieve data regarding the candidate units included in the model associated with the model ID 234. Upon acquiring information regarding the candidate units associated with the model ID 234, the model locator 240 may provide model data 244 that reflects this information to text-to-speech module 250.

The text-to-speech module 250 utilize the model data 244 received from the model locator 244 in generating synthesized speech 254. In some implementations, the text-to-speech module 250 may receive model data 244 for each of multiple portions of the text to be synthesized 204. That is, the processes described above in association with FIGS. 1 and 2 may be performed for each of multiple portions of textual input 204.

In such implementations, the text-to-speech module 250 may perform final unit selection using all of the model data 244 determined for the entirety of the textual input 204. In other words, the text-to-speech module 250 may select a unit from each model identified and conveyed in model data 244. Ultimately, the text-to-speech module 250 may produce synthesized speech 254, which is a concatenation of the recorded speech samples associated with the unit selected from among multiple candidate units identified for each portion of textual input 204. The synthesized speech 254 may, for example, audibly indicate the phrase, “hello there,” of the textual input 204.

In some implementations, the second neural network 220 may map each set of input acoustic features to multiple models. In these implementations, the second neural network 220 may output information which indicates each of the multiple models to which a given set of input acoustic features are mapped.

One or more modules downstream from the second neural network 220 may receive this information and select a particular one of the multiple hypotheses provided by the second neural network 220 for each portion of the textual input 204. For instance, the one or more modules downstream from the second neural network 220 may determine a confidence score for each one of the multiple models identified by the second neural network 220 that indicates a degree of confidence in each model being the most suitable model for the given portion of textual input 204.

The one or more modules may then select a subset of the multiple models identified by the second neural network 220 on the basis of confidence scores. Such confidence scores may be determined based on the models identified by the second neural network 220 for previous portions of textual input 204. The one or more modules may, for instance, consider the probability of occurrence of a particular sequence of models that corresponds to a sequence of portions of textual input.

For example, the one or more modules may determine that one of the multiple models identified by the second neural network 220 for a particular portion of text would likely not occur in sequence with a model identified by the second neural network 220 for a portion of text that immediately precedes the particular portion of text. In this example, the one or more modules may assign this particular model a relatively low confidence score. Accordingly, the one or more modules may select one or more models from the multiple models identified by the second neural network 220 for the particular portion of text with higher confidence scores.

The one or more modules may include the model locator 240, the text-to-speech module 250, and/or another data processing apparatus module downstream from the second neural network 220. In some examples, the model selection processes described above may be performed by the second neural network 230. For example, the second neural network 220 may be trained to only output one or more model identifiers in which the second neural network 220 may hold a relatively high degree confidence.

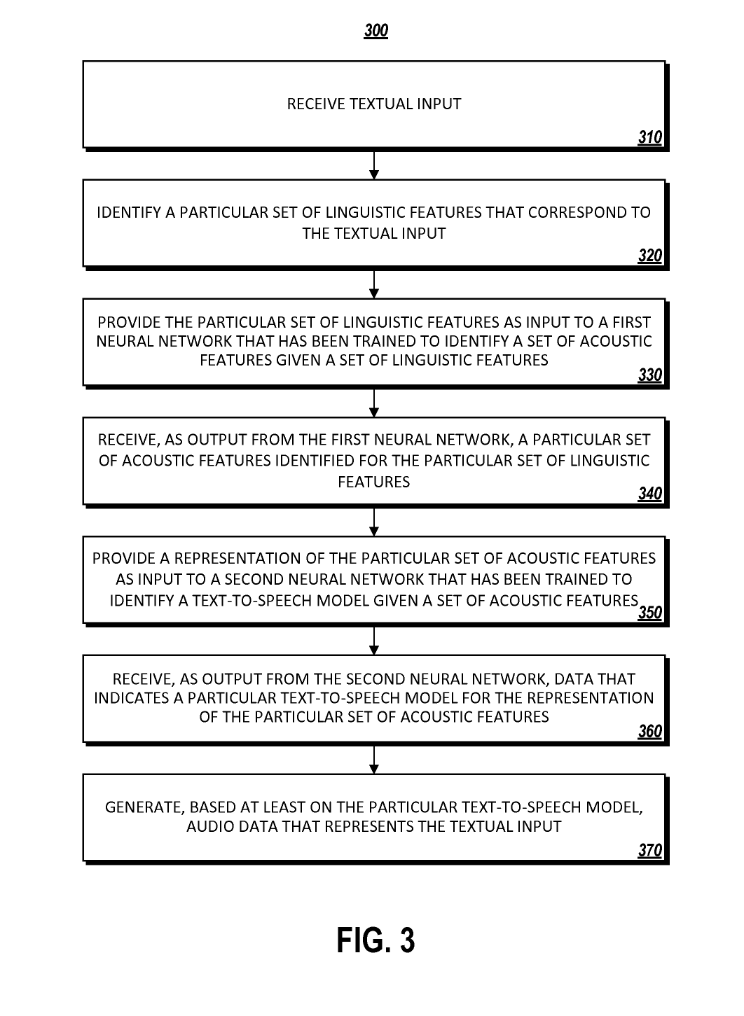

FIG. 3 is a flowchart of an example process 300 for providing text-to-speech services. The process 300 may be performed by data processing apparatus, such as the one or more computing devices described above in association with FIGS. 1 and 2 or another data processing apparatus.

At 310, the process 300 may include receiving textual input. The textual input received may be that which has been described above in association with text that is to be synthesized into speech. For example, a client device may provide the textual input over a network and request an audio representation. Alternatively, the textual input may be generated by the one or more computing devices, accessed from storage, received from another computing system, or obtained from another source.

At 320, the process 300 may include identifying a particular set of linguistic features that correspond to the textual input. For example, a linguistic feature extractor may identify linguistic features for at least a portion of the textual input. The set of linguistic features identified may include a sequence of phonetic units, such as phonemes, in a phonetic representation of the textual input.

At 330, the process 300 may include providing the particular set of linguistic features as input to a first neural network. The first neural network, which may be similar to that which has been described above in association with FIGS. 1 and 2, may have been trained to identify a set of acoustic features given a set of linguistic features. That is, the first neural network may map linguistic features, such as sequences of phonemes, to acoustic features. The acoustic features identified by the first neural network may be real values which parameterize audio, such as spectrum, fundamental frequency, and excitation parameters. At 340, the process 300 may include receiving a particular set of acoustic features identified for the particular set of linguistic features as output from the first neural network.

At 350, the process 300 may include providing a representation of the particular set of acoustic features as input to a second neural network. The second neural network, which may be similar to that which has been described above in association with FIGS. 1 and 2, may be a recurrent neural network and may have been trained to identify a text-to-speech model given a set of acoustic features. That is, the second neural network may map acoustic features, such as spectrum, fundamental frequency, and/or excitation parameters, to models. In addition, the second neural network may have been trained independently from the first neural network.

The model identified by the second neural network may be representative of a set of candidate units. At 360, the process 300 may include receiving data that indicates a particular text-to-speech model for the representation of the particular set of acoustic features as output from the second neural network. The data that indicates the particular text-to-speech model may, for example, be a model ID which references the particular set of candidate units of the particular model.

At 370, the process 300 may include generating, based at least on the particular text-to-speech model, audio data that represents the textual input. This audio data may, for example, be synthesized speech such as that which has been described above in association with FIGS. 1 and 2. The synthesized speech may be a concatenation of recorded speech samples.

Speech synthesis processes may be performed at least in part by a text-to-speech module. For each portion of the textual input, the text-to-speech module may, for instance, select a candidate unit from among the multiple candidate units included in the model identified for each portion of the textual input, respectively. The recorded speech samples associated with each selected unit may concatenated by the text-to-speech module. In this way, generating, based at least on the particular text-to-speech model, audio data that represents the textual input may include selecting one or more recorded speech samples based on the particular text-to-speech model indicated by the output of the second neural network.

In some implementations, the second neural network may also receive data that indicates a particular quantity of frames of audio data that are to be generated, which may be indicative of the number of acoustic features which may be needed in order to generate each linguistic feature. In some examples, the second neural network may perform its acoustic-model mapping based at least on the representation of acoustic features and the quantity of frames of audio data that are to be generated.

In these examples, the quantity of frames of audio data, or duration information, may be provided to the second neural network prior to portion 360 of the process 300. In some implementations, this information may be provided by a process that maps linguistic features to a quantity of frames of audio data that are to be generated. In these implementations, such mapping may be performed by another neural network or other suitable data processing apparatus module.

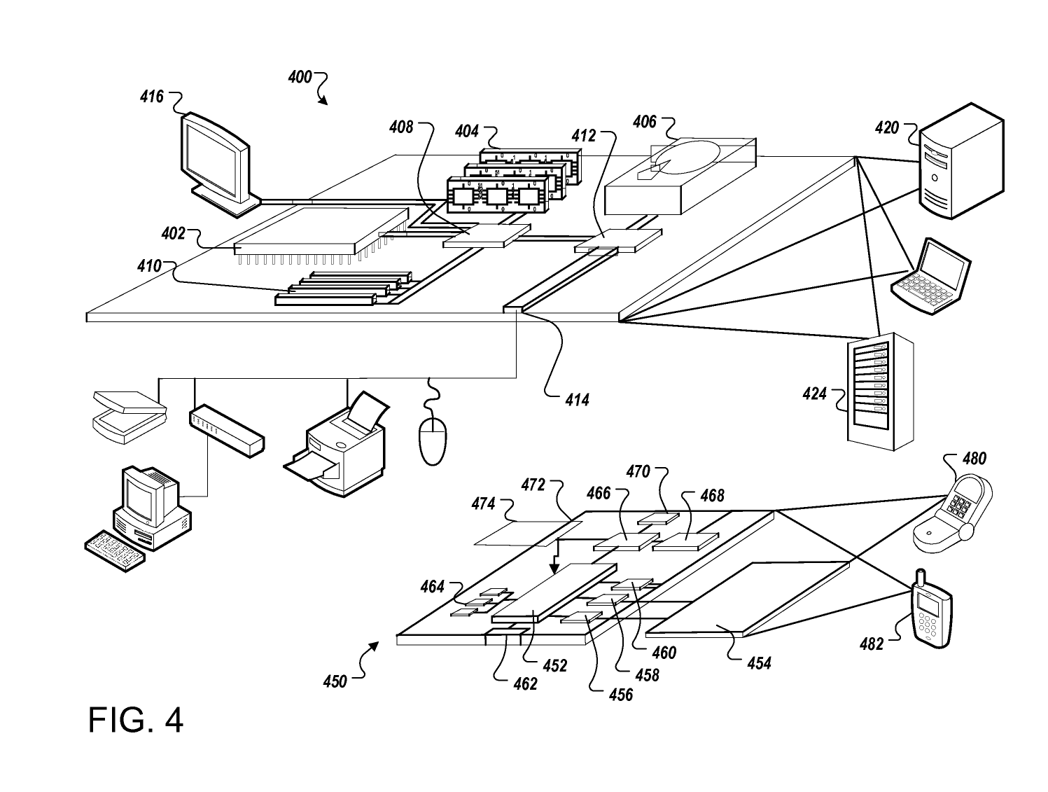

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate.

The processor 402 can process instructions for execution within the computing device 400, including instructions stored in the memory 404 or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations, e.g., as a server bank, a group of blade servers, or a multi-processor system.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations.

Instructions can be stored in an information carrier. The instructions, when executed by one or more processing devices, for example, processor 402, perform one or more methods, such as those described above. The instructions can also be stored by one or more storage devices such as computer- or machine-readable mediums, for example, the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is an example only.

In some implementations, the high-speed interface 408 is coupled to the memory 404, the display 416, e.g., through a graphics processor or accelerator, and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424.

Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user.

The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices, for example, processor 452, perform one or more methods, such as those described above. The instructions can also be stored by one or more storage devices, such as one or more computer- or machine-readable mediums, for example, the memory 464, the expansion memory 474, or memory on the processor 452. In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others.

Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound, e.g., voice messages, music files, etc., and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

What is claimed is:

1. A computer-implemented method comprising:
receiving textual input to a text-to-speech system;
identifying a particular set of linguistic features that correspond to the textual input;
providing the particular set of linguistic features as input to a first neural network that has been trained to identify a set of acoustic features given a set of linguistic features;
receiving, as output from the first neural network, a particular set of acoustic features identified for the particular set of linguistic features;
providing a representation of the particular set of acoustic features as input to a second neural network that has been trained to identify a text-to-speech model given a set of acoustic features;
receiving, as output from the second neural network, data that indicates a particular text-to-speech model for the representation of the particular set of acoustic features; and
generating, based at least on the particular text-to-speech model, audio data that represents the textual input.

2. The computer-implemented method of claim 1, wherein providing the representation of the particular set of acoustic features as input to the second neural network that has been trained to identify a text-to-speech model given a set of acoustic features, comprises providing the representation of the particular set of acoustic features as input to a second neural network that has been trained, independently from the first neural network, to identify a text-to-speech model given a set of acoustic features.

3. The computer-implemented method of claim 1, wherein receiving, as output from the first neural network, the particular set of acoustic features identified for the particular set of linguistic features comprises receiving, as output from the first neural network, a particular set of acoustic features including one or more of spectrum parameters, fundamental frequency parameters, and mixed excitation parameters identified for the particular set of linguistic features.

4. The computer-implemented method of claim 1 comprising:
providing, as input to the second neural network that has been trained to identify a text-to-speech model given a set of acoustic features, data that indicates a particular quantity of frames of audio data that are to be generated;
wherein receiving, as output from the second neural network, data that indicates the particular text-to-speech model for the representation of the particular set of acoustic features comprises receiving, as output from the second neural network, data that indicates a particular text-to-speech model for (i) the representation of the particular set of acoustic features and (ii) the particular quantity of frames of audio data to be generated; and
wherein generating, based at least on the particular text-to-speech model, audio data that represents the textual input comprises generating, based at least on the particular text-to-speech model, frames of audio data of at least the particular quantity that represent the textual input.

5. The computer-implemented method of claim 1, wherein the second neural network is a recurrent neural network.

6. The computer-implemented method of claim 1, wherein identifying the particular set of linguistic features that correspond to the textual input comprises identifying a sequence of linguistic features in a phonetic representation of the textual input.

7. The computer-implemented method of claim 1, wherein generating, based at least on the particular text-to-speech model, audio data that represents the textual input comprises selecting one or more recorded speech samples based on the particular text-to-speech model indicated by the output of the second neural network.

8. A system comprising:
one or more computers and one or more storage devices storing instructions that are operable, when executed by the one or more computers, to cause the one or more computers to perform operations comprising:
receiving textual input to a text-to-speech system;
identifying a particular set of linguistic features that correspond to the textual input;
providing the particular set of linguistic features as input to a first neural network that has been trained to identify a set of acoustic features given a set of linguistic features;
receiving, as output from the first neural network, a particular set of acoustic features identified for the particular set of linguistic features;
providing a representation of the particular set of acoustic features as input to a second neural network that has been trained to identify a text-to-speech model given a set of acoustic features;
receiving, as output from the second neural network, data that indicates a particular text-to-speech model for the representation of the particular set of acoustic features; and
generating, based at least on the particular text-to-speech model, audio data that represents the textual input.

9. The system of claim 8, wherein providing the representation of the particular set of acoustic features as input to the second neural network that has been trained to identify a text-to-speech model given a set of acoustic features, comprises providing the representation of the particular set of acoustic features as input to a second neural network that has been trained, independently from the first neural network, to identify a text-to-speech model given a set of acoustic features.

10. The system of claim 8, wherein receiving, as output from the first neural network, the particular set of acoustic features identified for the particular set of linguistic features comprises receiving, as output from the first neural network, a particular set of acoustic features including one or more of spectrum parameters, fundamental frequency parameters, and mixed excitation parameters identified for the particular set of linguistic features.

11. The system of claim 8, wherein the operations comprise:
providing, as input to the second neural network that has been trained to identify a text-to-speech model given a set of acoustic features, data that indicates a particular quantity of frames of audio data that are to be generated;
wherein receiving, as output from the second neural network, data that indicates the particular text-to-speech model for the representation of the particular set of acoustic features comprises receiving, as output from the second neural network, data that indicates a particular text-to-speech model for (i) the representation of the particular set of acoustic features and (ii) the particular quantity of frames of audio data to be generated; and
wherein generating, based at least on the particular text-to-speech model, audio data that represents the textual input comprises generating, based at least on the particular text-to-speech model, frames of audio data of at least the particular quantity that represent the textual input.

12. The system of claim 8, wherein the second neural network is a recurrent neural network.

13. The system of claim 8, wherein identifying the particular set of linguistic features that correspond to the textual input comprises identifying a sequence of linguistic features in a phonetic representation of the textual input.

14. The system of claim 8, wherein generating, based at least on the particular text-to-speech model, audio data that represents the textual input comprises selecting one or more recorded speech samples based on the particular text-to-speech model indicated by the output of the second neural network.

15. A non-transitory computer-readable storage device having instructions stored thereon that, when executed by a computing device, cause the computing device to perform operations comprising:
receiving textual input to a text-to-speech system;
identifying a particular set of linguistic features that correspond to the textual input;
providing the particular set of linguistic features as input to a first neural network that has been trained to identify a set of acoustic features given a set of linguistic features;
receiving, as output from the first neural network, a particular set of acoustic features identified for the particular set of linguistic features;
providing a representation of the particular set of acoustic features as input to a second neural network that has been trained to identify a text-to-speech model given a set of acoustic features;
receiving, as output from the second neural network, data that indicates a particular text-to-speech model for the representation of the particular set of acoustic features; and
generating, based at least on the particular text-to-speech model, audio data that represents the textual input.

16. The storage device of claim 15, wherein providing the representation of the particular set of acoustic features as input to the second neural network that has been trained to identify a text-to-speech model given a set of acoustic features, comprises providing the representation of the particular set of acoustic features as input to a second neural network that has been trained, independently from the first neural network, to identify a text-to-speech model given a set of acoustic features.

17. The storage device of claim 15, wherein receiving, as output from the first neural network, the particular set of acoustic features identified for the particular set of linguistic features comprises receiving, as output from the first neural network, a particular set of acoustic features including one or more of spectrum parameters, fundamental frequency parameters, and mixed excitation parameters identified for the particular set of linguistic features.

18. The storage device of claim 15 comprising:
providing, as input to the second neural network that has been trained to identify a text-to-speech model given a set of acoustic features, data that indicates a particular quantity of frames of audio data that are to be generated;
wherein receiving, as output from the second neural network, data that indicates the particular text-to-speech model for the representation of the particular set of acoustic features comprises receiving, as output from the second neural network, data that indicates a particular text-to-speech model for (i) the representation of the particular set of acoustic features and (ii) the particular quantity of frames of audio data to be generated; and
wherein generating, based at least on the particular text-to-speech model, audio data that represents the textual input comprises generating, based at least on the particular text-to-speech model, frames of audio data of at least the particular quantity that represent the textual input.

19. The storage device of claim 15, wherein identifying the particular set of linguistic features that correspond to the textual input comprises identifying a sequence of linguistic features in a phonetic representation of the textual input.

20. The storage device of claim 15, wherein generating, based at least on the particular text-to-speech model, audio data that represents the textual input comprises selecting one or more recorded speech samples based on the particular text-to-speech model indicated by the output of the second neural network.
